(19) United States
(12) Patent Application Publication
(10) Pub. No.: US 2010/0104276 A1
(43) Pub. Date: Apr. 29, 2010

(54) Level decline detecting apparatus, optical amplifier apparatus, and level decline detecting method

(75) Inventor: Kousuke Komaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/654,543

(22) Filed: Dec. 22, 2009

Related U.S. Application Data
(63) Continuation of application No. PCT/JP07/63311, filed on Jul. 3, 2007.

(51) Int. Cl. H04B 10/08

(52) U.S. Cl. 398/17

(57) ABSTRACT

A first comparing unit compares the signal light level with a predetermined threshold value and outputs the comparison result to a signal decline notifying unit. A difference calculating unit subtracts the signal light level from a monitoring light level and calculates a level difference ΔP. A second comparing unit compares the level difference ΔP between the monitoring light and the signal light with a relative threshold value and outputs the comparison result to the signal decline notifying unit. If the comparison result of the first comparing unit indicates the signal light level is not more than the predetermined threshold value or if the comparison result of the second comparing unit indicates that the level difference ΔP is not less than the relative threshold value, then the signal decline notifying unit outputs to a control unit a decline warning indicating a decline in the level of only the signal light.

### CROSS-REFERENCE TO RELATED APPLICATION(S)

This application is a continuation of International Application No. PCT/JP2007/063311, filed on Jul. 3, 2007, the entire contents of which are incorporated herein by reference.

### FIELD

The embodiments discussed herein are directed to a level decline detecting apparatus, an optical amplifier apparatus, and a level decline detecting method employed to detect, from a light signal formed by multiplexing a monitoring light used for transmission path monitoring and a signal light including data, a decline in the level of the signal light.

### BACKGROUND

In recent years, studies are being actively undertaken regarding a communication technology in which a plurality of lights having different wavelengths are subjected to wavelength division multiplexing (WDM) and transmitted through within an optical fiber. In the case of lights having different wavelengths, there is no occurrence of mutual light interference and it is also possible to independently superimpose data on each of the lights having different wavelengths. Thus, by employing the WDM technology, the information transmission efficiency can be improved in a dramatic manner.

In the WDM technology, to compensate the attenuation of a light signal transmitted through within an optical fiber; generally optical amplifiers are disposed in the transmission path such that the light signal is relayed while being amplified. In optical amplifiers, sometimes a rare-earth element such as erbium is used. An example of an optical amplifier using erbium is disclosed in Japanese Laid-open Patent Publication No. 11-4194. In the optical amplifier disclosed in Japanese Laid-open Patent Publication No. 11-4194, a wavelength shorter than the signal light on which actual data is superimposed is monitored as a monitoring wavelength for detecting defects occurring in the optical transmission system that transmits the signal light. That is, if a defect occurs in the optical transmission system thereby causing signal light interruption, then an amplified spontaneous emission (ASE) light is amplified by an amplifier and, as a result, the optical intensity of the monitoring wavelength increases. Due to an increase in the optical intensity of the monitoring wavelength, the defect in the optical transmission system is detected.

Besides, for example, Japanese Laid-open Patent Publication No. 2000-269902 discloses a technology of transmitting a light signal obtained by synthesizing a signal light and a monitoring light that has a different wavelength than the signal light and performing automatic level control (ALC) with the use of the monitoring light in optical repeaters that relay the light signal while amplifying the signal light. More particularly, in an optical transmission system disclosed in Japanese Laid-open Patent Publication No. 2000-269902, the signal light is amplified with optical repeaters #1 and #2 as illustrated in FIG. 1. The optical repeater #1 (optical repeater #2) includes a wavelength coupler unit 1 (wavelength coupler unit 6), an erbium doped fiber (EDF) 2 (EDF 7), a light monitoring circuit (hereinafter referred to as “OSC”) 3 (OSC 8), and a wavelength coupler unit 4 (wavelength coupler unit 9).

An input signal light that is input to the wavelength coupler unit 1 of the optical repeater #1 includes a signal light on which actual data is superimposed and a monitoring light having a different wavelength than the signal light. The wavelength coupler unit 1 demultiplexes the input signal light into the signal light and the monitoring light, outputs the signal light to the EDF 2, and outputs the monitoring light to the OSC 3.

The EDF 2 then amplifies the signal light and outputs the amplified signal light to the wavelength coupler unit 4. The OSC 3 sets an ALC reference level using the monitoring light, updates the monitoring light according to the gain of the EDF 2, and outputs the updated monitoring light to the wavelength coupler unit 4. Then, the wavelength coupler unit 4 multiplexes the amplified signal light and the updated modified light, and outputs the multiplexed light to a transmission optical fiber 5. The optical intensity of each wavelength of the light signal at a point A after being output from the wavelength coupler unit 4 is illustrated in FIG. 2. As illustrated in FIG. 2, the signal light includes lights having a plurality of wavelengths, with the wavelength bands ranging from about 1532 nm to 1563 nm. The monitoring light has a shorter wavelength as compared to the signal light and has a nearly equal optical intensity to the optical intensity of each light having a different wavelength included in the signal light. In this way, the light signal obtained by multiplexing the signal light and the monitoring light having mutually different wavelength bands are relayed to the optical repeater #2 via the transmission optical fiber 5.

In the optical repeater #2, the amplification of the signal light and the updating of the monitoring light is performed in an identical manner to that of the optical repeater #1. That is, the light signal input to the optical repeater #2 via the transmission optical fiber 5 is demultiplexed into the signal light and the monitoring light by the wavelength coupler unit 6. More particularly, the monitoring light is obtained by filtering the light signal with a suppression ratio, for example, illustrated in FIG. 3 such that the wavelength band of the signal light is suppressed. In an identical manner, the signal light is obtained by filtering the light signal with a suppression ratio, for example, illustrated in FIG. 4 such that the wavelength band of the monitoring light is suppressed.

The optical intensity of each wavelength of the light signal at a point B between the wavelength coupler unit 6 and the OSC 8 is illustrated in FIG. 5. As illustrated in FIG. 5, the wavelength band of the signal light is suppressed at the point B. Because of that, the light signal including the monitoring light as the primary component is input to the OSC 8. Then, the OSC 8 sets an ALC reference level in the EDF 7, updates the monitoring light according to the gain of the EDF 7, and outputs the updated monitoring light to the wavelength coupler unit 9. Similarly, the optical intensity of each wavelength of the light signal at a point C between the wavelength coupler unit 6 and the EDF 7 is illustrated in FIG. 6. As illustrated in FIG. 6, the wavelength band of the monitoring light is suppressed at the point C. Because of that, the light signal including the signal light as the primary component is input to the EDF 7. The EDF 7 then amplifies the signal light input thereto.

Subsequently, the wavelength coupler unit 9 multiplexes the amplified signal light and the updated modified light and outputs the obtained output signal light to an optical repeater (not illustrated) or a receiving terminal apparatus (not illustrated) disposed at a subsequent stage. In this way, in this optical transmission system, to the signal light is multiplexed the monitoring light having a different frequency than the signal light and then the multiplexed light is transmitted. Thus, the transmission quality within the transmission path of, for example, the transmission optical fiber 5 can be efficiently monitored using the monitoring light and the ALC can be properly performed at the time of amplification.

Meanwhile, in optical repeaters in an optical transmission system as described above, different suppression ratios are used at the time of demultiplexing the signal light and the monitoring light. Thus, there are times when the signal light is sufficiently suppressed but the monitoring light is not sufficiently suppressed. As is clear from the suppression ratios in the wavelength coupler unit 6 as illustrated in FIGS. 3 and 4, the suppression ratio used in suppressing the signal light for the purpose of outputting the monitoring light (see FIG. 3) is relatively high and the suppression ratio used in suppressing the monitoring light for the purpose of outputting the signal light (see FIG. 4) is relatively low.

That is done because of the possibility that, if the suppression ratio for suppressing the monitoring light is increased, then some portion of the suppressed band extends over the wavelength band of the signal light thereby causing suppression of the signal light on which data is superimposed. The suppression of the signal light leads to a decline in the level of the signal light prior to the amplification performed by an EDF. Thus, the noise level increases relatively thereby causing degradation in the noise characteristics. For that reason, the suppression of the signal light causes degradation in the transmission quality and shortening of the relaying distance over which each optical repeater can relay the signal light. Hence, to prevent suppression of the pre-amplification signal light, the suppression ratio with respect to the monitoring light is set at a relatively low level.

However, if the monitoring light is included in the light signal that is to be treated as the post-demultiplexing signal light, then various problems may occur. For example, consider a case when the monitoring light is not sufficiently suppressed by a wavelength coupler. In that case, even if the signal light is interrupted in the transmission path prior to the wavelength coupler, the fact that the optical intensity of the signal light has declined is not detected. Thus, an optical repeater happens to output, as the signal light, the light signal including the monitoring light as the primary component. Moreover, since the light signal including the monitoring light as the primary constituent is treated as the signal light and subjected to control operations such as the ALC, the gain of an EDF is possibly not properly adjusted after the signal light interruption is resolved.

More particularly, in the optical transmission system illustrated in FIG. 1, the light signal at the point C is amplified by the EDF 7. At that time, assuming that signal light interruption had occurred prior to the wavelength coupler unit 6; if the monitoring light is not sufficiently suppressed in the wavelength coupler unit 6, then the optical intensity of the signal light at the point C becomes as illustrated in FIG. 7. That is, due to signal light interruption, the wavelength band of the signal light includes only the noise component; while due to insufficient suppression of the monitoring light, some monitoring light remains in the wavelength band thereof. Even in that case, a high optical intensity of the remaining monitoring light leads to an increase in the optical intensity of the entire light signal such that it may not be possible to detect the decline in the optical intensity of the signal light.

Because of that, despite the fact that the light signal input to the EDF 7 does not include the signal light and with the decline in the level of the signal light remaining undetected, the ALC is performed to control the gain of the EDF 7 based on the optical intensity of the light signal not including the signal light. In that case, the gain of the EDF 7 gets set to a value that is best suited for the light signal including only the monitoring light and the noise component. As a result, when the signal light interruption is resolved, the gain of the EDF may be found to be excessive.

Such a problem becomes more prominent if an optical repeater has a large dynamic range. That is, a large dynamic range of an optical repeater generates a possibility of a high optical intensity of the input monitoring light. As a result, the suppression of the monitoring light with the filtering performed by a wavelength coupler proves insufficient on a more frequent basis. More particularly, explanation about the output light from the optical repeater #1 in FIG. 1 and the input light to the optical repeater #2 in FIG. 1 is given in the form of a level diagram in FIG. 8. In FIG. 8, two cases are illustrated: a first case when the output light from the optical repeater #1 includes the monitoring light (represented by dashed arrows in FIG. 8) in the range of 2 dBm to 5 dBm and the signal light (represented by solid arrows in FIG. 8) in the range of 0 dBm to 19 dBm; and a second case when the optical repeater #2 has a different dynamic range.

In the first case, the optical repeater #2 has a relatively small dynamic range. Moreover, the input light to the optical repeater #2 is the light signal that includes the monitoring light in the range of −24 dBm to −14 dBm and the signal light in the range of −23 dBm to 0 dBm and that has suffered from propagation loss in the transmission optical fiber 5. Herein, it is assumed that a signal light interruption level for detecting signal light interruption is −26 dBm such that signal light interruption is detected at half the value of the minimum level of the signal light. In the first case, the optical intensity of the monitoring light input to the optical repeater #2 is −14 dBm at a maximum. Thus, if the suppression ratio with respect to the monitoring light in the wavelength coupler unit 6 is 16 dBm as illustrated in FIG. 4; then the optical intensity of the monitoring light, which is included in the light signal output from the wavelength coupler unit 6 to the EDF 7, is equal to or lower than −30 (=−14-16) dBm. In that condition, if signal light interruption occurs, then the optical intensity of the light signal including the monitoring light and the noise component is necessarily equal to or lower than −26 dBm. Because of that, occurrence of signal light interruption is detected without fail.

In comparison, in the second case, the optical repeater #2 has a relatively large dynamic range. Moreover, the input light to the optical repeater #2 is the light signal that includes the monitoring light in the range of −24 dBm to 4 dBm and the signal light in the range of −23 dBm to 18 dBm and that has suffered from propagation loss in the transmission optical fiber 5. Herein, identical to the first case, it is assumed that a signal light interruption level for detecting signal light interruption is −26 dBm; while the noise component is assumed to have amplitude of 3 dBm at a maximum. In the second case, since the optical intensity of the monitoring light input to the optical repeater #2 is 4 dBm at a maximum, the optical intensity of the monitoring light included in the light signal output from the wavelength coupler unit 6 to the EDF 7 is equal to or lower than −12 (=4-16) dBm, which is higher than the signal light interruption level of −26 dBm. That is why, in the second case, there is a possibility that occurrence of signal light interruption is not detected.

Besides, for example, while monitoring the light signal to be output to the EDF 7 in the optical repeater #2 illustrated in FIG. 2; if the light signal includes the monitoring light that cannot be sufficiently suppressed to or below a certain level, then the level of the light signal does not reach the lower limit of monitoring despite the fact that the signal light is in an interrupted state. That makes it difficult to verify whether the level of the signal light has declined. Thus, it becomes difficult to determine whether the level of the monitored light signal is that of the actual signal light or that of the insufficiently suppressed monitoring light.

Such a problem also becomes more prominent if an optical repeater has a large dynamic range. That is, as the dynamic range of the optical repeater goes on increasing, the signal light and the monitoring light are not sufficiently demultiplexed thereby making it difficult to detect a decline in the level of the signal light. Yet, because of a high demand for optical repeaters that can be employed in various systems, it is becoming essential to increase the dynamic range of optical repeaters.

### SUMMARY

According to an aspect of an embodiment of the invention, a level decline detecting apparatus for detecting, from a light signal formed by multiplexing a monitoring light used for transmission path monitoring and a signal light including data, a decline in a level of the signal light, includes an obtaining unit that obtains, from the light signal input via a transmission path, a signal light level having a wavelength band level of the monitoring light suppressed and a monitoring light level having a wavelength band level of the signal light suppressed; a calculating unit that subtracts the signal light level from the monitoring light level obtained by the obtaining unit and calculates a level difference; a comparing unit that compares the level difference calculated by the calculating unit with a relative threshold value corresponding to a maximum level difference occurable between the monitoring light level and the signal light level; and an output unit that outputs, if a comparison result of the comparing unit indicates that the level difference calculated by the calculating unit is equal to or larger than the relative threshold value, a decline warning indicating a decline in the signal light level.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of a configuration of an optical transmission system using a monitoring light;

FIG. 2 is a graph of the optical intensity of each wavelength of a light signal output from an optical repeater;

FIG. 3 is a graph of an exemplary suppression ratio with respect to a signal light;

FIG. 4 is a graph of an exemplary suppression ratio with respect to a monitoring light;

FIG. 5 is a graph of the optical intensity of each wavelength of a demultiplexed light signal;

FIG. 6 is a graph of the optical intensity of each wavelength of another demultiplexed light signal;

FIG. 7 is a graph of the optical intensity of each wavelength of still another demultiplexed light signal;

FIG. 8 is an exemplary level diagram regarding optical repeaters;

FIG. 9 is a block diagram of a configuration of an optical amplifier apparatus according to a first embodiment;

FIG. 10 is a block diagram of an internal configuration of a decline detecting unit according to the first embodiment;

FIG. 11 is a flowchart for explaining the operations performed by the decline detecting unit according to the first embodiment;

FIG. 12 is a level diagram for explaining a relative threshold value Rₜₕ according to the first embodiment;

FIG. 13 is a block diagram of an internal configuration of the decline detecting unit according to a second embodiment;

FIG. 14 is a flowchart for explaining the operations performed by the decline detecting unit according to the second embodiment; and

FIG. 15 is a level diagram for explaining a lower limit Pₗᵢₘ according to the second embodiment.

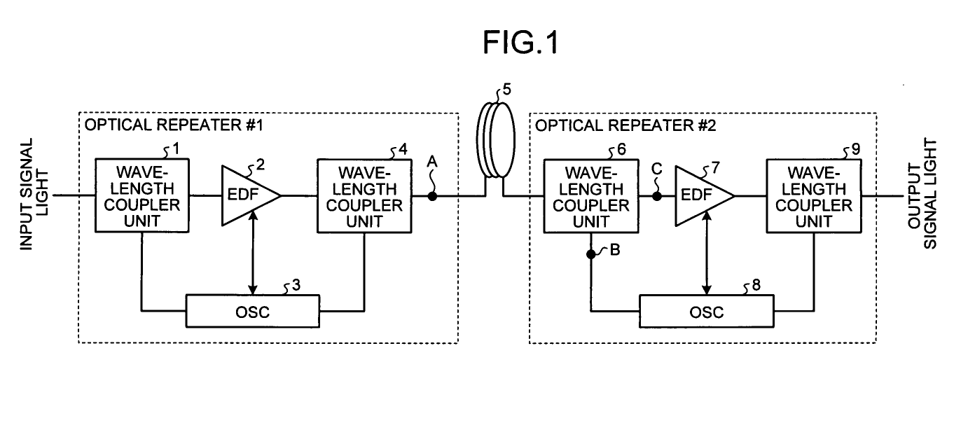

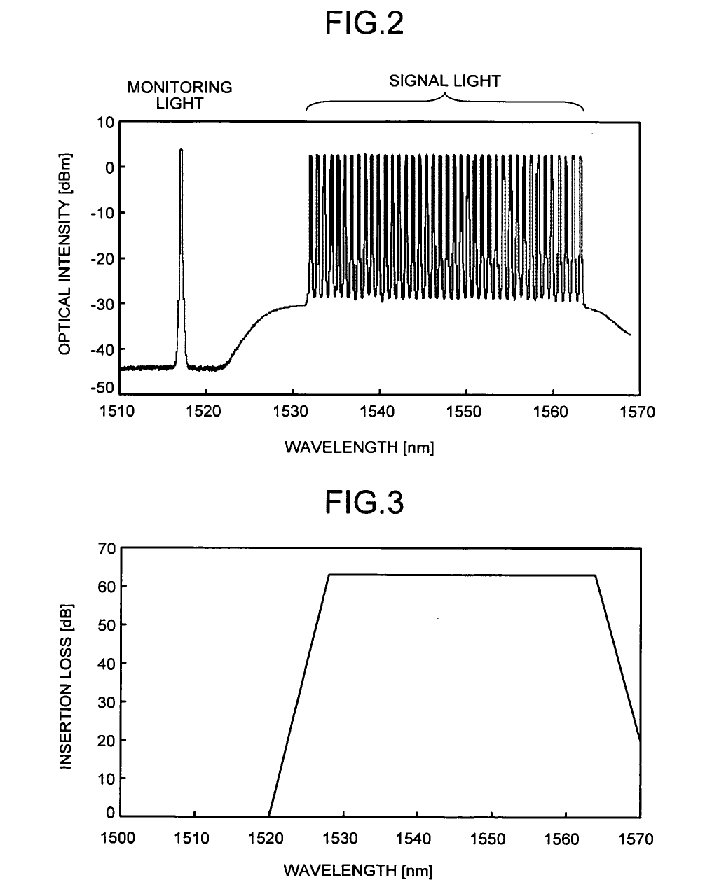

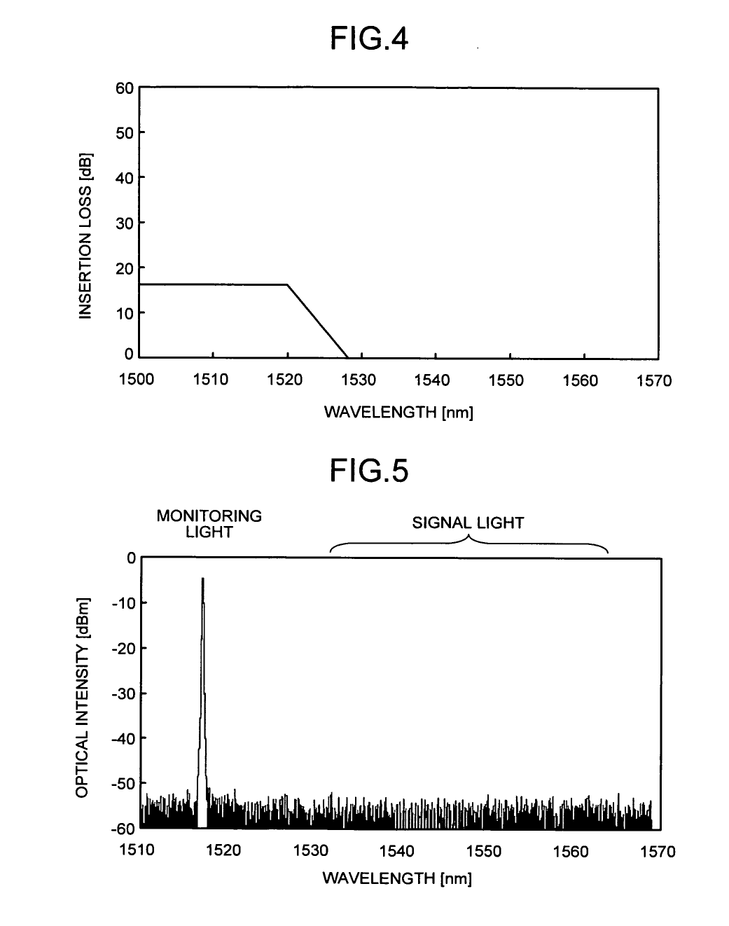

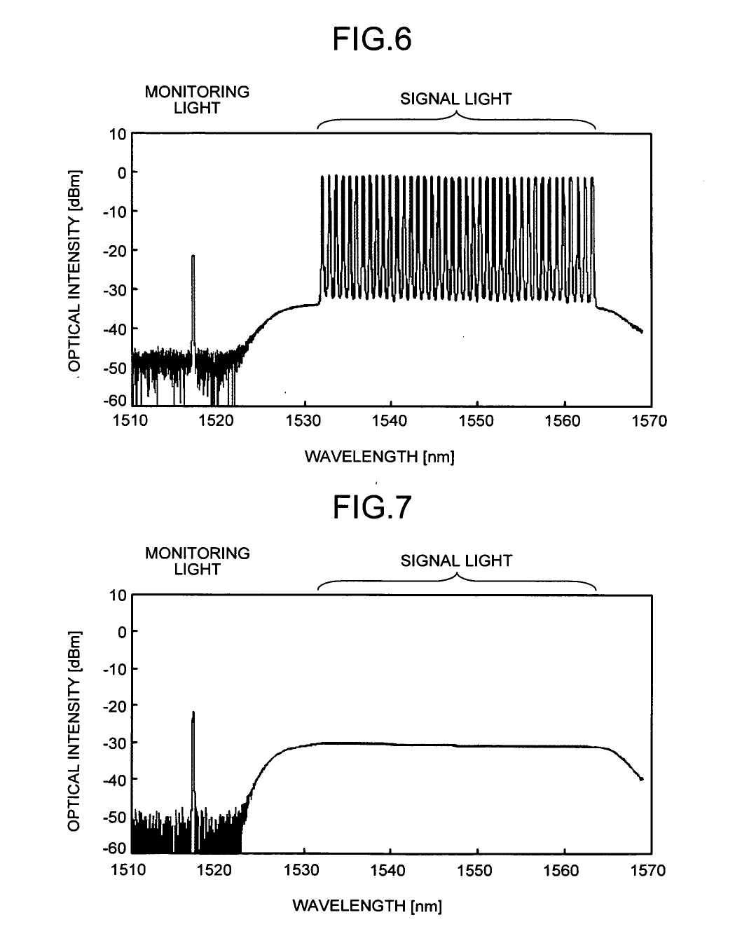

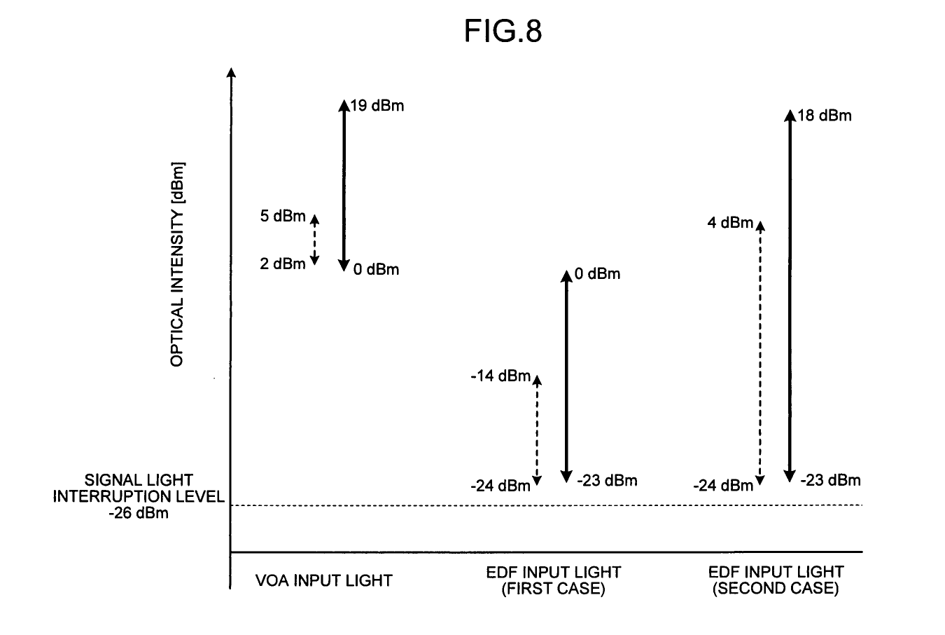

### DESCRIPTION OF EMBODIMENTS

The inventor of the present invention focused on the fact that the monitoring light is not relevant to the transmission quality because it is not superimposed with target data for transmission and is used only in monitoring the condition of the transmission path, and the fact that, by relatively increasing the suppression ratio with respect to the signal light, it is possible to obtain the monitoring light with sufficiently suppressed signal light. Then, it occurred to the inventor that, on the basis of the optical density of the obtained monitoring light, by relatively determining the optical intensity of the signal light having an insufficiently suppressed monitoring light added thereto; it is possible to accurately determine whether the level of the signal light has declined. That notion led to the making of the present invention. Thus, the gist of the present invention is as follows. By comparing the optical intensity of the signal-light-free monitoring light and the optical intensity of the signal light having an insufficiently suppressed monitoring light added thereto, it is possible to detect whether the optical density of only the signal light has declined. Preferred embodiments of the present invention will be explained with reference to accompanying drawings.

### [a] First Embodiment

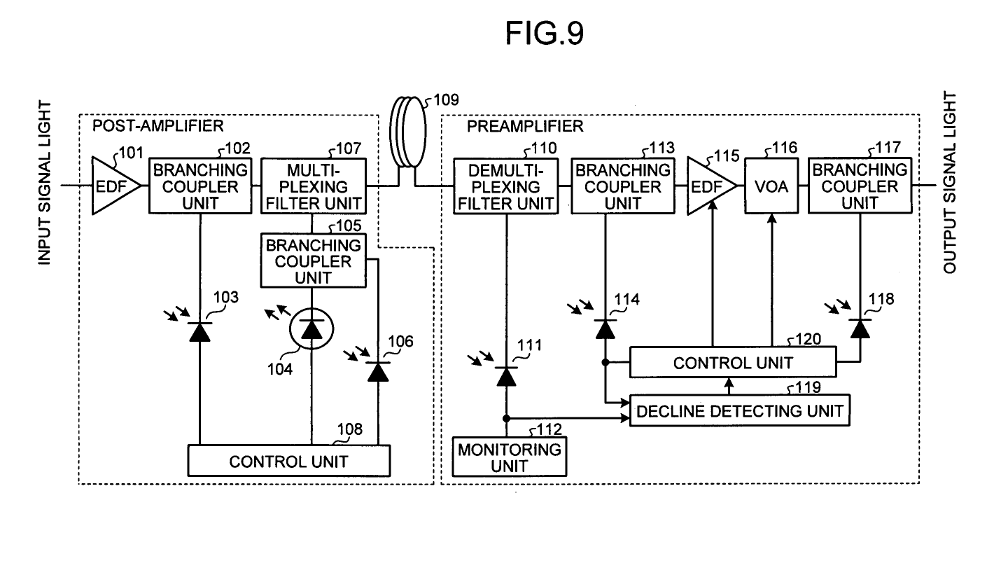

FIG. 9 is a block diagram of an essential configuration of an optical transmission system according to a first embodiment of the present invention. The optical transmission system illustrated in FIG. 9 is broadly configured from a post-amplifier and a preamplifier. The post-amplifier includes an erbium doped fiber (EDF) 101, a branching coupler unit 102, a photodiode (hereinafter abbreviated as “PD”) 103, a laser diode (hereinafter abbreviated as “LD”) 104, a branching coupler unit 105, a PD 106, a multiplexing filter unit 107, and a control unit 108. The preamplifier includes a demultiplexing filter unit 110, a PD 111, a monitoring unit 112, a branching coupler unit 113, a PD 114, an EDF 115, a variable optical attenuator (VOA) 116, a branching coupler unit 117, a PD 118, a decline detecting unit 119, and a control unit 120. The post-amplifier and the preamplifier are connected via a transmission optical fiber 109.

The EDF 101 is an optical fiber with erbium ion doped to the core thereof. When a pump light of a predetermined band is absorbed, the EDF 101 amplifies an input signal light that is input to the post-amplifier. Meanwhile, since erbium ion is used as a rare-earth element in the EDF 101, the amplified input signal light has a wavelength band of 1550 nm.

The branching coupler unit 102 performs branching of the signal light amplified by the EDF 101 and then outputs it to the PD 103 and the multiplexing filter unit 107.

The PD 103 detects the signal light output from the branching coupler unit 102 and generates an electric current specific to the optical intensity of the signal light. By doing that, the PD 103 notifies the optical intensity of the signal light to the control unit 108.

The LD 104 emits, under the control of the control unit 108, a monitoring light used in monitoring the transmission path that includes the transmission optical fiber 109. More particularly, as the monitoring light, the LD 104 emits light having a wavelength band of, for example, 1510 nm that is shorter than the wavelength band of 1550 nm of the signal light. However, as long as the wavelength bands of the monitoring light and the signal light are different, the wavelength band of the monitoring light can also be longer than the wavelength band of the signal light.

The branching coupler unit 105 performs branching of the monitoring light emitted by the LD 104 and then outputs it to the PD 106 and the multiplexing filter unit 107.

The PD 106 detects the monitoring light output from the branching coupler unit 105 and generates an electric current specific to the optical intensity of the monitoring light. By doing that, the PD 106 notifies the optical intensity of the monitoring light to the control unit 108.

The multiplexing filter unit 107 multiplexes the signal light output from the branching coupler unit 102 and the monitoring light output from the branching coupler unit 105, and sends the obtained light signal to the preamplifier via the transmission optical fiber 109.

The control unit 108 monitors the optical intensity of the monitoring light notified by the PD 106 and at the same time controls the emission of the monitoring light from the LD 104 or controls the gain in the EDF 101 based on the optical intensity of the signal light notified by the PD 103.

The transmission optical fiber 109 is an optical fiber that connects the post-amplifier to the preamplifier. While being transmitted through within the transmission optical fiber 109, the light signal output from the post-amplifier suffers from propagation loss.

The demultiplexing filter unit 110 receives the light signal from the transmission optical fiber 109, performs filtering of the wavelength bands of the signal light and the monitoring light at predetermined suppression ratios, and demultiplexes the light signal into the signal light and the monitoring light. Then, the demultiplexing filter unit 110 outputs the monitoring light to the PD 111 and outputs the signal light to the branching coupler unit 113. In addition, since an increase in the suppression ratio with respect to the monitoring light may lead to the suppression of the signal light on which data is superimposed, the demultiplexing filter unit 110 sets the suppression ratio with respect to the monitoring light at a relatively low level and sets the suppression ratio with respect to the signal light at a relatively high level. Accordingly, the demultiplexing filter unit 110 outputs, to the PD 111, the pure monitoring light with the signal light present in the light signal being sufficiently suppressed and outputs, to the branching coupler unit 113, the signal light having added thereto the monitoring light that was present in the light signal and was not sufficiently suppressed.

The PD 111 detects the monitoring light output from the demultiplexing filter unit 110 and generates an electric current specific to the optical intensity of the monitoring light. By doing that, the PD 111 notifies the optical intensity of the monitoring light, which has already passed through the transmission optical fiber 109, to the monitoring unit 112 and the decline detecting unit 119.

The monitoring unit 112 monitors the optical intensity of the monitoring light notified by the PD 111 and performs certain monitoring tasks such as monitoring propagation loss inside the transmission optical fiber 109.

The branching coupler unit 113 performs branching of the signal light output from the demultiplexing filter unit 110 and then outputs it to the PD 114 and the EDF 115.

The PD 114 detects the signal light output from the branching coupler unit 113 and generates an electric current specific to the optical intensity of the signal light. By doing that, the PD 114 notifies the optical intensity of the signal light, which is yet to be amplified by the EDF 115, to the decline detecting unit 119 and the control unit 120. Meanwhile, in the signal light detected by the PD 114 remains the monitoring light that was not sufficiently suppressed in the demultiplexing filter unit 110.

The EDF 115 is an optical fiber identical to the EDF 101 and amplifies the signal light output from the branching coupler unit 113 with the gain in accordance with the automatic gain control (AGC) performed by the control unit 120. Meanwhile, since erbium ion is used as a rare-earth element, the EDF 115 amplifies the signal light of 1550 nm wavelength band output from the branching coupler unit 113.

The VOA 116 is a variable attenuator that can adjust the amount of attenuation of a signal. According to the ALC performed by the control unit 120, the VOA 116 attenuates the signal light amplified by the EDF 115.

The branching coupler unit 117 performs branching of the signal light that has been amplified by the EDF 115 and attenuated by the VOA 116, and then outputs it to the PD 118. In addition, the branching coupler unit 117 outputs the amplified signal light as output signal light.

The PD 118 detects the signal light output from the branching coupler unit 117 and generates an electric current specific to the optical intensity of the signal light. By doing that, the PD 118 notifies the optical intensity of the signal light that has been amplified by the EDF 115 to the control unit 120.

The decline detecting unit 119 refers to the optical intensity of the monitoring light detected by the PD 111 and the optical intensity of the signal light detected by the PD 114, and detects a decline in the level of the signal light. That is, since there is a possibility that the signal light detected by the PD 114 includes some of the monitoring light, the decline detecting unit 119 performs relative comparison based on the pure monitoring light detected by the PD 111 and detects a decline in the level of only the pure signal light. The detailed configuration and the operations of the decline detecting unit 119 are described later in detail.

The control unit 120 refers to the optical intensity of the pre-amplification signal light notified from the PD 114 and the optical intensity of the post-amplification signal light notified from the PD 118, and performs the AGC to determine the gain of the EDF 115. That gain is used in maintaining the optical intensity of the post-amplification signal light at a constant level. Moreover, the control unit 120 detects the optical intensity of the pre-attenuation signal light and the post-attenuation signal light in the VOA 116, performs the ALC to determine the amount of attenuation for the VOA 116, and sets the determined amount of attenuation in the VOA 116. At the time of performing the ALC, the control unit 120 verifies whether the decline detecting unit 119 has detected a decline in the level of the signal light and, if a decline in the level of the signal light has been detected, stops performing the ALC.

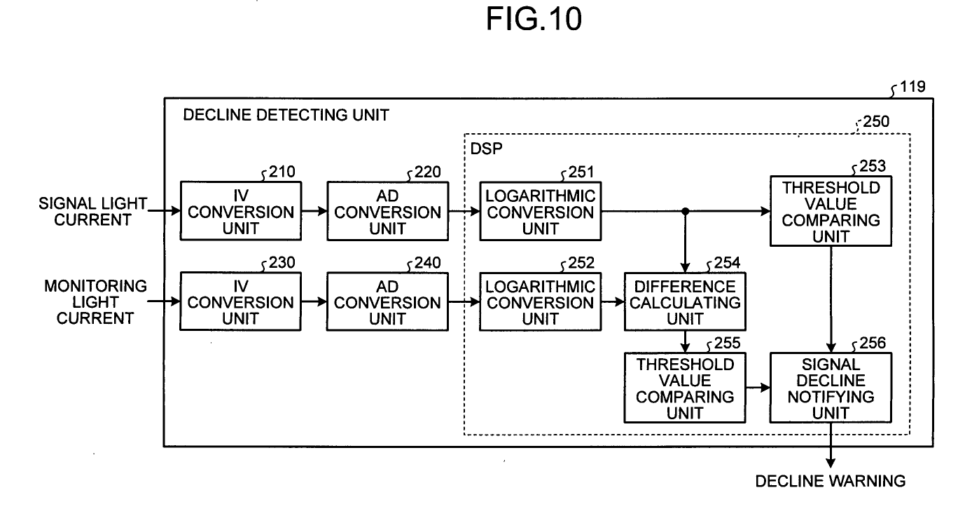

FIG. 10 is a block diagram of an internal configuration of the decline detecting unit 119 according to the present embodiment. The decline detecting unit 119 illustrated in FIG. 10 includes an IV conversion unit 210, an AD conversion unit 220, an IV conversion unit 230, an AD conversion unit 240, and a digital signal processor (DSP) 250.

The IV conversion unit 210 receives as input a signal light current I_{sig} corresponding to the optical intensity of the signal light detected by the PD 114, performs current-to-voltage conversion on the signal light current I_{sig}, and outputs a signal light voltage V_{sig} corresponding to the signal light current I_{sig} to the AD conversion unit 220.

The AD conversion unit 220 performs analog-to-digital (AD) conversion on the signal light voltage V_{sig} and outputs a digital value of the signal light voltage V_{sig} to the DSP 250.

The IV conversion unit 230 receives as input a monitoring light current Iₛᵥ corresponding to the optical intensity of the monitoring light detected by the PD 111, performs current-to-voltage conversion on the monitoring light current Iₛᵥ, and outputs a monitoring light voltage Vₛᵥ corresponding to the monitoring light current Iₛᵥ to the AD conversion unit 240.

The AD conversion unit 240 performs AD conversion on the monitoring light voltage Vₛᵥ and outputs a digital value of the monitoring light voltage Vₛᵥ to the DSP 250.

The DSP 250 determines, on the basis of the optical intensity of the monitoring light, whether the optical intensity of the signal light having some of the monitoring light added thereto has declined to or below a predetermined level. That is, the DSP 250 determines whether the difference obtained by subtracting the signal light detected by the PD 114 from the monitoring light detected by the PD 111 is equal to or larger than a predetermined threshold value. If the difference is equal to or larger than the predetermined threshold value, then the DSP 250 detects that the optical intensity of only the signal light has declined and outputs to the control unit 120 a decline warning indicating a decline in the level of the signal light. Moreover, the DSP 250 outputs a decline warning to the control unit 120 even when the signal light detected by the PD 114 is equal to or smaller than the predetermined threshold value. In particular, the DSP 250 includes logarithmic conversion units 251 and 252, a threshold value comparing unit 253, a difference calculating unit 254, a threshold value comparing unit 255, and a signal decline notifying unit 256.

The logarithmic conversion unit 251 performs logarithmic conversion with respect to the signal light voltage V_{sig} output by the AD conversion unit 220 and outputs an obtained signal light level P_{sig} to the threshold value comparing unit 253 and the difference calculating unit 254.

The logarithmic conversion unit 252 performs logarithmic conversion with respect to the monitoring light voltage Vₛᵥ output by the AD conversion unit 240 and outputs an obtained monitoring light level Pₛᵥ to the difference calculating unit 254.

The threshold value comparing unit 253 compares the signal light level P_{sig} with a predetermined threshold value Pₜₕ and outputs the comparison result to the signal decline notifying unit 256. In the signal light level P_{sig} that the threshold value comparing unit 253 compares with the predetermined threshold value Pₜₕ, the monitoring light level not sufficiently suppressed in the demultiplexing filter unit 110 is sometimes included. However, if the signal light level P_{sig} is too small irrespective of whether the monitoring light level is included, then it can be considered that the optical intensity of only the signal light has also declined. Thus, the threshold value comparing unit 253 determines whether the optical density of only the signal light has absolutely declined by comparing the signal light level P_{sig} with the predetermined threshold value Pₜₕ.

The difference calculating unit 254 subtracts the signal light level P_{sig} from the monitoring light level Pₛᵥ to calculate a level difference ΔP. That is, the difference calculating unit 254 calculates the level difference between the monitoring light and the signal light that have passed through the same transmission optical fiber 109. By doing that, it becomes possible to determine whether the optical density of the signal light, free of the propagation loss effect, has relatively declined.

The threshold value comparing unit 255 compares the level difference ΔP between the monitoring light and the signal light with a predetermined relative threshold value Rₜₕ and outputs the comparison result to the signal decline notifying unit 256. The relative threshold value Rₜₕ is that level difference between the monitoring light and the signal light which, even if the monitoring light level is maximum and the signal light level is minimum at the time of being output from the multiplexing filter unit 107 (in other words, at the time of being output from the post-amplifier), does not occur unless a defect occurs with respect to the signal light before it passes out of the transmission optical fiber 109. That is, if the level difference ΔP is equal to or larger than the predetermined relative threshold value Rₜₕ, then it can be considered that a defect such as signal light interruption has occurred inside or prior to the transmission optical fiber 109.

If the comparison result of the threshold value comparing unit 253 indicates that the signal light level P_{sig} is equal to or smaller than the predetermined threshold value Pₜₕ or if the comparison result of the threshold value comparing unit 255 indicates that the level difference ΔP is equal to or larger than the predetermined relative threshold value Rₜₕ, then the signal decline notifying unit 256 outputs to the control unit 120 a decline warning indicating a decline in the optical intensity of the signal light.

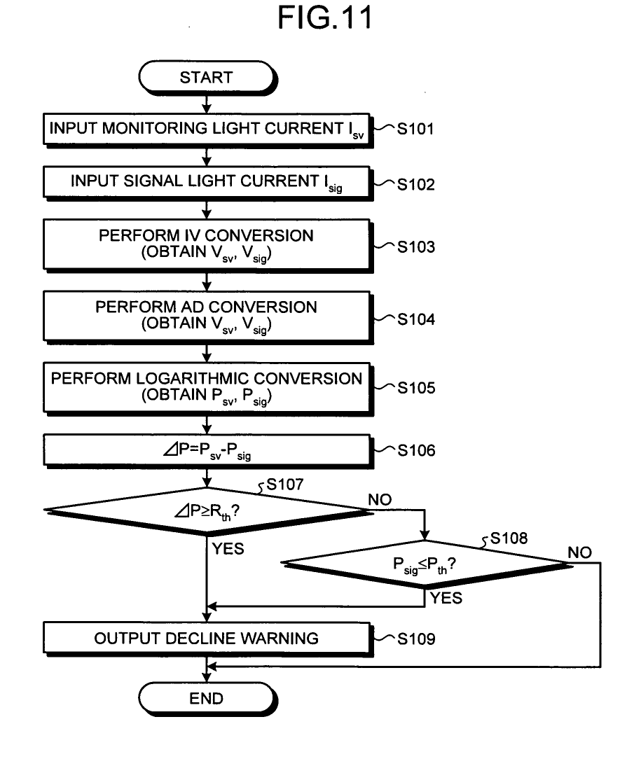

Given below is the description with reference to a flowchart illustrated in FIG. 11 of the operations performed by the decline detecting unit 119 configured in the abovementioned manner.

Firstly, the monitoring light current Iₛᵥ corresponding to the optical intensity of the monitoring light detected by the PD 111 is input to the IV conversion unit 230 (Step S101), while the signal light current I_{sig} corresponding to the optical intensity of the signal light detected by the PD 114 is input to the IV conversion unit 210 (Step S102). Then, the IV conversion units 210 and 230 perform current-to-voltage conversion to respectively obtain the signal light voltage V_{sig} and the monitoring light voltage Vₛᵥ (Step S103). The signal light voltage V_{sig} is then output from the IV conversion unit 210 to the AD conversion unit 220, while the monitoring light voltage Vₛᵥ is output from the IV conversion unit 230 to the AD conversion unit 240.

Subsequently, the AD conversion units 220 and 240 perform AD conversion to respectively obtain digital values of the signal light voltage V_{sig} and the monitoring light voltage Vₛᵥ (Step S104), which are then input to the DSP 250. Once the signal light voltage V_{sig} and monitoring light voltage Vₛᵥ are input to the DSP 250, the logarithmic conversion units 251 and 252 perform logarithmic conversion to respectively obtain the signal light level P_{sig} and the monitoring light level Pₛᵥ (Step 105). The signal light level P_{sig} is then output from the logarithmic conversion unit 251 to the threshold value comparing unit 253 and the difference calculating unit 254, while the monitoring light level Pₛᵥ is output from the logarithmic conversion unit 252 to the difference calculating unit 254.

Then, the difference calculating unit 254 subtracts the signal light level P_{sig} from the monitoring light level Pₛᵥ and obtains the level difference ΔP (Step S106). The level difference ΔP is output to the threshold value comparing unit 255, which then compares the level difference ΔP with the relative threshold value Rₜₕ (Step S107) and outputs the comparison result to the signal decline notifying unit 256.

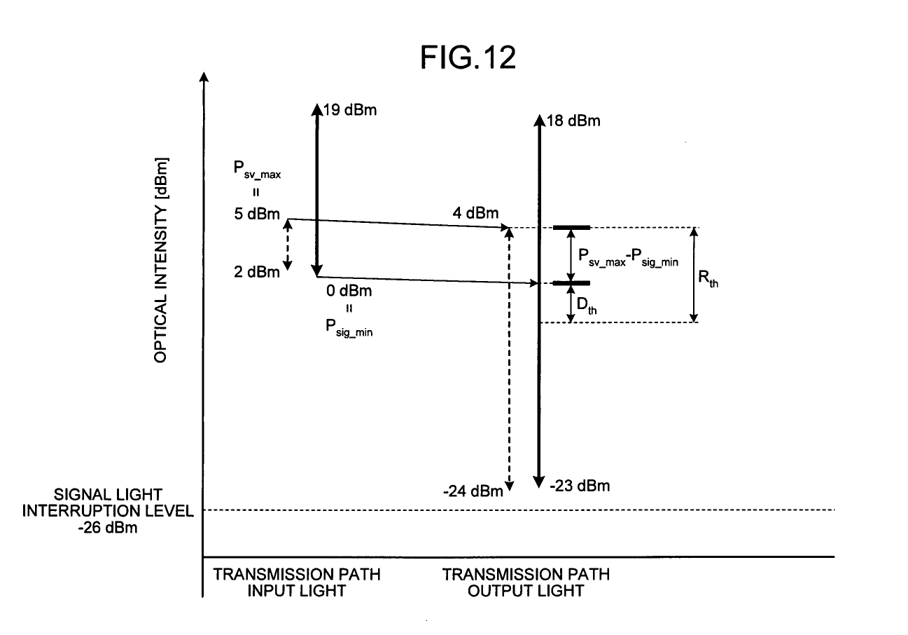

The explanation regarding the relative threshold value Rₜₕ is given with reference to a level diagram illustrated in FIG. 12. FIG. 12 illustrates a range of the optical intensity of the signal light and the monitoring light in the light signal output from the multiplexing filter unit 107 (i.e., output from the post-amplifier) and a range of the optical intensity of the signal light and the monitoring light in the light signal output from the transmission optical fiber 109 (i.e., input to the preamplifier). In FIG. 12, the ranges of the signal light are illustrated with solid arrows, while the ranges of the monitoring light are illustrated with dashed arrows. Since, in the WDM technology, a plurality of lights having different wavelengths are multiplexed to form the signal light, the optical intensity of the entire signal light tends to be larger than the optical intensity of the monitoring light, though the optical intensity of each light included in the signal light is comparable (about 2 dBm to 5 dBm) to the optical intensity of the monitoring light.

Herein, it is assumed that, in the light signal input to the transmission optical fiber 109, the optical intensity of the monitoring light is at a maximum level Pₛᵥ_{_{—}}ₘₐₓ and the optical intensity of the signal light is at a minimum level P_{sig}_{_{—}}ₘᵢₙ. In that case, the monitoring light and the signal light suffer from a nearly equal propagation loss in the transmission optical fiber 109 before being output therefrom. Thus, if the light signal output from the transmission optical fiber 109 is demultiplexed in an ideal manner by the demultiplexing filter unit 110, then the level difference ΔP obtained by subtracting the signal light level P_{sig} from the monitoring light level Pₛᵥ will be equal to (Pₛᵥ_{_{—}}ₘₐₓ−P_{sig}_{_{—}}ₘᵢₙ) at a maximum. However, in practice, some of the monitoring light remains in the signal light level P_{sig} due to the insufficient suppression in the demultiplexing filter unit 110. Because of that, the signal light level P_{sig} is higher than the actual level of only the signal light. As a result, the level difference ΔP becomes smaller than (Pₛᵥ_{_{—}}ₘₐₓ−P_{sig}_{_{—}}ₘᵢₙ).

Meanwhile, if a margin Dₜₕ is added by taking into consideration the error in the wavelength dependency or the like of the propagation loss inside the transmission optical fiber 109, then the level difference ΔP does not exceed (Pₛᵥ_{_{—}}ₘₐₓ−P_{sig}_{_{—}}ₘᵢₙ)+Dₜₕ unless a defect such as signal light interruption occurs. For that reason, the relative threshold value Rₜₕ in the present embodiment is defined as Equation (1) given below.

Rₜₕ=(Pₛᵥ_{_{—}}ₘₐₓ−P_{sig}_{_{—}}ₘᵢₙ₎₊Dₜₕ (1)

More particularly, in FIG. 12, if the margin Dₜₕ is assumed to be 3 dBm and the level difference ΔP is equal to or larger than 8 (=(5−0)+3) dBm, then it can be considered that a defect such as signal light interruption has occurred for certain. Thus, assuming that the monitoring light level in the light signal output from the transmission optical fiber 109 is 4 dBm; then, for the signal light level P_{sig} smaller than −4 dBm, it is determined that the optical intensity of only the signal light has declined in an exceptional manner. The signal light level P_{sig} sometimes includes the monitoring light level that has remained after passing through the demultiplexing filter unit 110. However, because of the inclusion of the monitoring light level, the signal light level P_{sig} rather increases and thus the level difference ΔP decreases. For that reason, if the level difference ΔP becomes equal to or larger than the relative threshold value Rₜₕ, it can be said that a defect has occurred for certain with respect to the signal light.

Returning to the explanation of the flowchart in FIG. 11, while the comparison result of the threshold value comparing unit 255 is output to the signal decline notifying unit 256; the threshold value comparing unit 253 compares the signal light level P_{sig} with the predetermined threshold value Pₜₕ (Step S108) and outputs the comparison result to the signal decline notifying unit 256.

If the comparison result of the threshold value comparing unit 255 indicates that the level difference ΔP is equal to or larger than the relative threshold value Rₜₕ (Yes at Step S107), then the signal decline notifying unit 256 outputs to the control unit 120 a decline warning indicating an exceptional decline in the level of the signal light (Step S109). Moreover, even if the level difference ΔP is smaller than the relative threshold value Rₜₕ (No at Step S107); if the comparison result of the threshold value comparing unit 253 indicates that the signal light level P_{sig} is equal to or smaller than the predetermined threshold value Pₜₕ (Yes at Step S108), then the signal decline notifying unit 256 outputs a decline warning to the control unit 120 (Step S109). Thus, except for the case when the level difference ΔP is smaller than the relative threshold value Rₜₕ (No at Step S107) and the signal light level P_{sig} is larger than the predetermined threshold value Pₜₕ (No at Step S108), the signal decline notifying unit 256 outputs a decline warning.

As described above, in the present embodiment, by determining whether the signal light level is equal to or smaller than a predetermined threshold value, a decline in the signal light level is absolutely detected. Moreover, by determining whether the difference between the monitoring light level and the signal light level is equal to or larger than a relative threshold value, a decline in the signal light level is relatively detected. Because of that, even if the monitoring light is not sufficiently suppressed at the time of demultiplex filtering and some of the monitoring light level is included in the signal light level, comparing the level difference with the relative threshold value enables achieving reliable detection of a decline in the level of only the signal light.

### [b] Second Embodiment

A second embodiment of the present invention is characterized by the following point. During the monitoring of the transmitted signal light level, even if the monitoring light level included in the signal light level causes the apparent signal light level to increase above the lower limit; a decline in the actual signal light level prompts a notice indicating that the lower limit has been reached.

In the abovementioned first embodiment, a decline warning is output when the signal light level declines due to some defect. However, generally the transition in the signal light level is monitored as required. In such a case, since the apparent signal light level sometimes includes the level of insufficiently suppressed monitoring light, the apparent signal light level can be found to be within the monitoring range despite the fact that the actual signal light level might have reached or exceeded the lower limit of monitoring. In the present embodiment, even if the apparent signal light level is found to be within the monitoring range; when the actual signal light level reaches or exceeds the lower limit of monitoring, a notice of that effect is output to the user performing the monitoring task.

An essential configuration of the optical transmission system according to the second embodiment is identical to that of the optical transmission system according to the first embodiment (see FIG. 9). Hence, the explanation of the essential configuration is not repeated. In the present embodiment, the decline detecting unit 119 detects if the signal light level has reached the lower limit of monitoring and notifies the same to the control unit 120. Then, the control unit 120 informs, for example, the user monitoring the signal light level of the fact that the signal light level has reached the lower limit of monitoring.

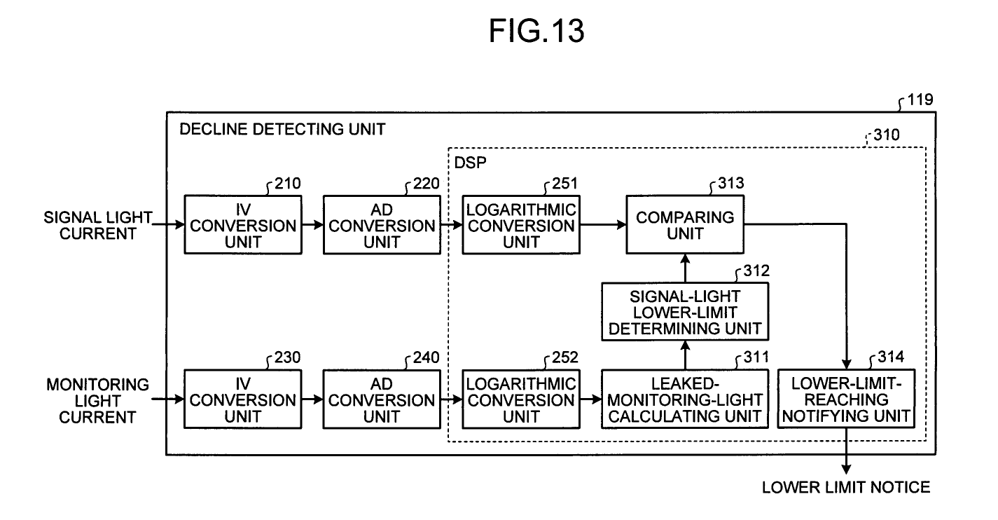

FIG. 13 is a block diagram of an internal configuration of the decline detecting unit 119 according to the present embodiment. In FIG. 13, the constituent elements identical to those illustrated in FIG. 10 are assigned the same reference numerals and their explanation is not repeated. The decline detecting unit 119 illustrated in FIG. 13 includes a DSP 310 as a substitute to the DSP 250 of the decline detecting unit 119 illustrated in FIG. 10. Although not illustrated in FIG. 13, the DSP 310 includes processing blocks identical to those in the DSP 250 and performs identical functions as the DSP 250. In the following description, the explanation is given only for the processing blocks specific to the second embodiment as illustrated in FIG. 13.

The DSP 310 calculates, from the monitoring light level P″, the leaked monitoring light level remaining in the apparent signal light level P_{sig} after the suppression is performed in the demultiplexing filter unit 110. Then, the DSP 310 determines whether the actual signal light level included in the apparent signal light level P_{sig} has reached the lower limit of monitoring. If the actual signal light level has reached the lower limit of monitoring, then the DSP 310 notifies the same to the control unit 120. In particular, the DSP 310 includes the logarithmic conversion units 251 and 252, a leaked-monitoring-light calculating unit 311, a signal-light lower-limit determining unit 312, a comparing unit 313, and a lower-limit-reaching notifying unit 314.

The leaked-monitoring-light calculating unit 311 subtracts, from the monitoring light level Pₛᵥ, a minimum value Fₛᵤₚ of the suppression ratio with respect to the monitoring light in the demultiplexing filter unit 110 and calculates a leaked monitoring light level Lₘₐₓ that is the maximum leaked monitoring light level includable in the apparent signal light level P_{sig}. That is, the leaked-monitoring-light calculating unit 311 calculates that the monitoring light level up to the leaked monitoring light level Lₘₐₓ at a maximum is included in the apparent signal light level P_{sig} that is output from the logarithmic conversion units 251.

The signal-light lower-limit determining unit 312 compares a monitoring level P_{id} during the dark current period with the leaked monitoring light level Lₘₐₓ and determines the larger of the two levels as a lower limit Pₗᵢₘ of the apparent signal light level P_{sig}. That is, if the monitoring level P_{id} during the dark current period is larger than the leaked monitoring light level Lₘₐₓ, then the signal-light lower-limit determining unit 312 determines, as the lower limit Pₗᵢₘ of monitoring, the monitoring level P_{id} of the period when the signal light level is not input. On the other hand, if the leaked monitoring light level Lₘₐₓ is larger than the monitoring level P_{id} during the dark current period, then the signal-light lower-limit determining unit 312 determines the leaked monitoring light level Lₘₐₓ included in the apparent signal light level P_{sig} as the lower limit Pₗᵢₘ of monitoring.

The comparing unit 313 compares the lower limit Pₗᵢₘ set by the signal-light lower-limit determining unit 312 with the apparent signal light level P_{sig} and outputs the comparison result to the lower-limit-reaching notifying unit 314. That is, the comparing unit 313 compares the apparent signal light level P_{sig} with the monitoring level P_{id} during the dark current period or with the leaked monitoring light level Lₘₐₓ and determines whether the actual signal light level included in the apparent signal light level P_{sig} has reached the lower limit of monitoring.

If the comparison result of the comparing unit 313 indicates that the apparent signal light level P_{sig} is equal to or smaller than the lower limit Pₗᵢₘ, then the lower-limit-reaching notifying unit 314 outputs a lower limit notice indicating that the actual signal light level has reached the lower limit of monitoring to the control unit 120.

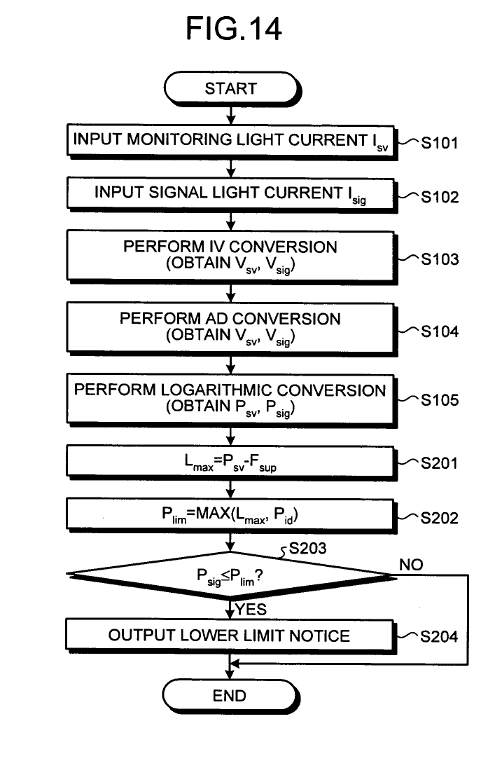

Given below is the description with reference to a flowchart illustrated in FIG. 14 of the operations performed by the decline detecting unit 119 configured in the abovementioned manner. In FIG. 14, the steps identical to those illustrated in FIG. 11 are assigned the same step numbers and their explanation is not repeated in detail.

In the present embodiment too, the IV conversion units 210 and 230 perform current-to-voltage conversion to respectively obtain the signal light voltage V_{sig} and the monitoring light voltage Vₛᵥ (Steps S101 to S103). Then, the AD conversion units 220 and 240 perform AD conversion to respectively obtain digital values of the signal light voltage V_{sig} and monitoring light voltage Vₛᵥ (Step S104), which are then input to the DSP 310. Once the signal light voltage V_{sig} and the monitoring light voltage Vₛᵥ are input to the DSP 310, the logarithmic conversion units 251 and 252 perform logarithmic conversion to respectively obtain the signal light level P_{sig} and the monitoring light level Pₛᵥ (Step S105). The signal light level P_{sig} is then output from the logarithmic conversion unit 251 to the comparing unit 313, while the monitoring light level Pₛᵥ is output from the logarithmic conversion unit 252 to the leaked-monitoring-light calculating unit 311.

Then, the leaked-monitoring-light calculating unit 311 subtracts, from the monitoring light level Pₛᵥ, the minimum suppression ratio Fₛᵤₚ with respect to the monitoring light in the demultiplexing filter unit 110 and calculates the leaked monitoring light level Lₘₐₓ that is the maximum leaked monitoring light level added to the signal light level P_{sig} (Step S201). That indicates that the signal light level P_{sig} includes the leaked monitoring light level equal to Lₘₐₓ at a maximum. The leaked monitoring light level Lₘₐₓ calculated in the leaked-monitoring-light calculating unit 311 is output to the signal-light lower-limit determining unit 312.

In the signal-light lower-limit determining unit 312 is stored in advance the monitoring level P_{id} during the dark current period when the signal light level is not input. Upon receiving as input the leaked monitoring light level Lₘₐₓ, the signal-light lower-limit determining unit 312 compares the monitoring level P_{id} during the dark current period with the leaked monitoring light level Lₘₐₓ and determines the larger of the two levels as the lower limit Pₗᵢₘ of the apparent signal light level P_{sig} (Step S202). The lower limit Pₗᵢₘ is then output to the comparing unit 313.

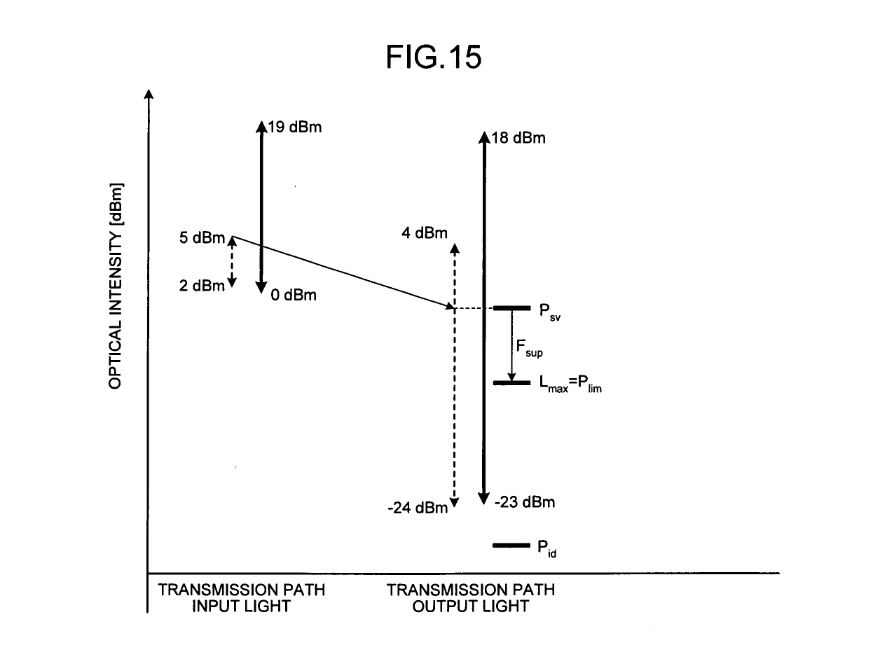

The explanation regarding the lower limit Pₗᵢₘ is given with reference to a level diagram illustrated in FIG. 15. FIG. 15 illustrates a range of the optical intensity of the signal light and the monitoring light in the light signal output from the multiplexing filter unit 107 (i.e., output from the post-amplifier) and a range of the optical intensity of the signal light and the monitoring light in the light signal output from the transmission optical fiber 109 (i.e., input to the preamplifier). In FIG. 15, the ranges of the signal light are illustrated with solid arrows, while the ranges of the monitoring light are illustrated with dashed arrows. Since, in the WDM technology, a plurality of lights having different wavelengths are multiplexed to form the signal light, the optical intensity of the entire signal light tends to be larger than the optical intensity of the monitoring light, though the optical intensity of each light in the signal light is comparable (about 2 dBm to 5 dBm) to the optical intensity of the monitoring light.

Herein, in the light signal input to the transmission optical fiber 109, the optical intensity of the monitoring light is assumed to be 5 dBm; and in the light signal output from the transmission optical fiber 109, the optical intensity of the monitoring light is assumed to be the monitoring light level Pₛᵥ. The light signal output from the transmission optical fiber 109 is demultiplexed by the demultiplexing filter unit 110. However, if the suppression ratio with respect to the monitoring light is assumed to be equal to Fₛᵤₚ, then the light signal output as the signal light happens to include the monitoring light of the level Lₘₐₓ (=Pₛᵥ−Fₛᵤₚ).

Thus, as illustrated in FIG. 15, if the leaked monitoring light level Lₘₐₓ is larger than the monitoring level P_{id} during the dark current period and if the apparent signal light level P_{sig} is equal to the leaked monitoring light level Lₘₐₓ; then the level of the monitoring light that is remaining by not getting suppressed is monitored even if the apparent signal light level is found to be within the monitoring range. Thus, in the present embodiment, if the leaked monitoring light level Lₘₐₓ is larger than the monitoring level P_{id} during the dark current period, then the leaked monitoring light level Lₘₐₓ is set as the lower limit Pₗᵢₘ of the apparent signal light level P_{sig} such that it can be detected that the actual signal light is not included in the apparent signal light level P_{sig}.

If the leaked monitoring light level Lₘₐₓ is equal to or smaller than the monitoring level P_{id} during the dark current period; then the monitoring level P_{id} during the dark current period is set as the lower limit Pₗᵢₘ of the apparent signal light level P_{sig} such that, irrespective of whether the apparent signal light level P_{sig} includes the monitoring light level, it can be detected that the actual signal light has reached the lower limit of monitoring.

Returning to the explanation of the flowchart in FIG. 14, after the lower limit Pₗᵢₘ is output to the comparing unit 313 from the signal-light lower-limit determining unit 312; the comparing unit 313 compares the apparent signal light level P_{sig} output from the logarithmic conversion units 251 with the lower limit Pₗᵢₘ (Step S203) and outputs the comparison result to the lower-limit-reaching notifying unit 314.

If the comparison result of the comparing unit 313 indicates that the apparent signal light level P_{sig} is equal to or smaller than the lower limit Pₗᵢₘ (Yes at Step S203), then the lower-limit-reaching notifying unit 314 outputs to the control unit 120 a lower limit notice indicating that either the actual signal light is not at all included in the apparent signal light level P_{sig} or is equal to or smaller than the monitoring level during the dark current period (Step S204). On the other hand, if the apparent signal light level P_{sig} is larger than the lower limit Pₗᵢₘ (No at Step S203), then a lower limit notice is not output because the actual signal light level is within the normal monitoring range.

Upon receiving the lower limit notice, the control unit 120 performs processing to display a notice indicating that the actual signal light level has reached the lower limit of monitoring on a displaying device such as a display that is used to display, for example, the apparent signal light level P_{sig}. Because of that, in the case when the apparent signal light level P_{sig} is found to be within the normal monitoring range but when the apparent signal light level P_{sig} includes only the leaked monitoring light level Lₘₐₓ, the user can be informed of the fact that the actual signal light level has reached the lower limit of monitoring.

In this way, according to the present embodiment, the larger of the leaked monitoring light level, which remains in the signal light level without getting suppressed at the time of demultiplex filtering, and the monitoring level during the dark current period is set as the lower limit of monitoring with respect to the apparent signal light level. When the apparent signal light level reaches the lower limit of monitoring, a lower limit notice is output. For that reason, even if the apparent signal light level is found to be within the normal monitoring range, it becomes possible to distinguish between a case when the actual signal light level is within the normal monitoring range and a case when the apparent signal light level is within the normal monitoring range due to the presence of the leaked monitoring light. Thus, if there is a decline in the actual signal light level, then the user can be informed that the actual signal light level has reached the lower limit of monitoring.

Moreover, as described above, the second embodiment can be implemented in combination with the first embodiment. That is, as described in the first embodiment, a level difference between the monitoring light level and the apparent signal light level can be compared with the relative threshold value and a decline warning can be output indicating that the actual signal light level has declined. Moreover, if the actual signal light level reaches the lower limit of monitoring, then a lower limit notice can be output. In that case, by appropriately adjusting the margin Dₜₕ of the relative threshold value, it can be made sure that the decline warning is output first when the actual signal light level declines. Thus, by configuring the control unit 120 to notify the decline warning to the user, the user gets informed of the decline warning before actually getting informed of the lower limit notice of monitoring.

According to the configuration of an embodiment, even if the monitoring light is not sufficiently suppressed at the time of demultiplex filtering and some of the monitoring light level is included in the signal light level, comparing the level difference with the relative threshold value enables achieving detection of a decline in the level of only the signal light. Hence, even when the dynamic range with respect to an input light is increased at the time of optical amplification, a decline in the level of the signal light on which data is superimposed can be detected in a reliable manner.

According to the configuration of an embodiment, a decline in the level of the signal light can be detected with the use of the absolute amplitude of the signal light level. Thus, with the help of both of the relative determination and the absolute determination, it becomes possible to more reliably detect a decline in the level of the signal light.

According to the configuration of an embodiment, a level difference that can occur only when a defect occurs with respect to the signal light can be set as the relative threshold value. For that reason, it becomes possible to prevent a situation when, despite the fact that no decline has occurred in the signal light level, a decline is detected.

According to the configuration of an embodiment, even if the apparent signal light level is found to be within the normal monitoring range, it becomes possible to distinguish between a case when the actual signal light level is within the normal monitoring range and a case when the apparent signal light level is within the normal monitoring range due to the presence of the leaked monitoring light.

According to the configuration of an embodiment, a level that can be reached only when the signal light declines in an exceptional manner can be set as the lower limit. For that reason, irrespective of the monitoring level for the apparent signal light level, it becomes possible to detect a decline in the level of the actual signal light.

According to the configuration of an embodiment, it is possible to calculate the maximum leaked monitoring light level that is includable in the signal light level. For that reason, when the leaked monitoring light level is larger than the monitoring level during the dark current period, it can be reliably detected that the actual signal light level has reached the lower limit of monitoring.

According to the configuration of an embodiment, even if the monitoring light is not sufficiently suppressed at the time of demultiplex filtering and some of the monitoring light level is included in the signal light level, comparing the level difference with the relative threshold value enables achieving detection of a decline in the level of only the signal light. Hence, even when the dynamic range with respect to an input light is increased at the time of optical amplification, a decline in the level of the signal light on which data is superimposed can be detected in a reliable manner.

According to the configuration of an embodiment, even if the apparent signal light level is found to be within the normal monitoring range, it becomes possible to distinguish between a case when the actual signal light level is within the normal monitoring range and a case when the apparent signal light level is within the normal monitoring range due to the presence of the leaked monitoring light.

According to the method of an embodiment, even if the monitoring light is not sufficiently suppressed at the time of demultiplex filtering and some of the monitoring light level is included in the signal light level, comparing the level difference with the relative threshold value enables achieving detection of a decline in the level of only the signal light. Hence, even when the dynamic range with respect to an input light is increased at the time of optical amplification, a decline in the level of the signal light on which data is superimposed can be detected in a reliable manner.

According to the method of an embodiment, even if the apparent signal light level is found to be within the normal monitoring range, it becomes possible to distinguish between a case when the actual signal light level is within the normal monitoring range and a case when the apparent signal light level is within the normal monitoring range due to the presence of the leaked monitoring light.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A level decline detecting apparatus for detecting, from a light signal formed by multiplexing a monitoring light used for transmission path monitoring and a signal light including data, a decline in a level of the signal light, the level decline detecting apparatus comprising:
an obtaining unit that obtains, from the light signal input via a transmission path, a signal light level having a wavelength band level of the monitoring light suppressed and a monitoring light level having a wavelength band level of the signal light suppressed;
a calculating unit that subtracts the signal light level from the monitoring light level obtained by the obtaining unit and calculates a level difference;
a comparing unit that compares the level difference calculated by the calculating unit with a relative threshold value corresponding to a maximum level difference occurable between the monitoring light level and the signal light level; and
an output unit that outputs, if a comparison result of the comparing unit indicates that the level difference calculated by the calculating unit is equal to or larger than the relative threshold value, a decline warning indicating a decline in the signal light level.

2. The level decline detecting apparatus according to claim 1, further comprising a threshold value comparing unit that compares the signal light level with a predetermined threshold value, wherein
the output unit outputs a decline warning if a comparison result of the threshold value comparing unit indicates that the signal light level is equal to or smaller than the predetermined threshold value or if the comparison result of the comparing unit indicates that the level difference is equal to or larger than the relative threshold value.

3. The level decline detecting apparatus according to claim 1, wherein the comparing unit sets, as the relative threshold value, a value obtained by adding a predetermined margin to a difference between a maximum level of pre-transmission monitoring light and a minimum level of pre-transmission signal light.

4. A level decline detecting apparatus for detecting, from a light signal formed by multiplexing a monitoring light used for transmission path monitoring and a signal light including data, a decline in a level of the signal light, the level decline detecting apparatus comprising:
an obtaining unit that obtains, from the light signal input via a transmission path, a signal light level having a wavelength band level of the monitoring light suppressed and a monitoring light level having a wavelength band level of the signal light suppressed;
a calculating unit that calculates, from the monitoring light level obtained by the obtaining unit, a leaked monitoring light level remaining in the signal light level having the wavelength band level of the monitoring light suppressed;
a determining unit that determines, as a lower limit of monitoring with respect to the signal light level, either one of the leaked monitoring light level calculated by the calculating unit and a monitoring level during a dark current period when the signal light level obtained by the obtaining unit is not input;
a comparing unit that compares the lower limit set by the determining unit with the signal light level obtained by the obtaining unit; and
an output unit that outputs, if a comparison result of the comparing unit indicates that the signal light level is equal to or smaller than the lower limit, a lower limit notice indicating that the signal light level has declined outside a monitoring range.

5. The level decline detecting apparatus according to claim 4, wherein the determining unit determines, as the lower limit of monitoring, larger of the leaked monitoring light level and the monitoring level during the dark current period.

6. The level decline detecting apparatus according to claim 4, wherein the calculating unit subtracts, from the monitoring light level obtained by the obtaining unit, a minimum value of suppression ratio with respect to the monitoring light that is used to obtain the signal light level and calculates the leaked monitoring light level.

7. An optical amplifier apparatus for amplifying a signal light when a light signal formed by multiplexing a monitoring light used for transmission path monitoring and the signal light including data is input via a transmission path, the optical amplifier apparatus comprising:
an obtaining unit that obtains, from the light signal input via the transmission path, a signal light level having a wavelength band level of the monitoring light suppressed and a monitoring light level having a wavelength band level of the signal light suppressed;
a calculating unit that subtracts the signal light level from the monitoring light level obtained by the obtaining unit and calculates a level difference;
a comparing unit that compares the level difference calculated by the calculating unit with a relative threshold value corresponding to a maximum level difference occurable between the monitoring light level and the signal light level; and
an output unit that outputs, if a comparison result of the comparing unit indicates that the level difference calculated by the calculating unit is equal to or larger than the relative threshold value, a decline warning indicating a decline in the signal light level.

8. An optical amplifier apparatus for amplifying a signal light when a light signal formed by multiplexing a monitoring light used for transmission path monitoring and the signal light including data is input via a transmission path, the optical amplifier apparatus comprising:
an obtaining unit that obtains, from the light signal input via the transmission path, a signal light level having a wavelength band level of the monitoring light suppressed and a monitoring light level having a wavelength band level of the signal light suppressed;
a calculating unit that calculates, from the monitoring light level obtained by the obtaining unit, a leaked monitoring light level remaining in the signal light level having the wavelength band level of the monitoring light suppressed;
a determining unit that determines, as a lower limit of monitoring with respect to the signal light level, either one of the leaked monitoring light level calculated by the calculating unit and a monitoring level during a dark current period when the signal light level obtained by the obtaining unit is not input;
a comparing unit that compares the lower limit determined by the determining unit with the signal light level obtained by the obtaining unit; and
an output unit that outputs, if a comparison result of the comparing unit indicates that the signal light level is equal to or smaller than the lower limit, a lower limit notice indicating that the signal light level has declined outside a monitoring range.

9. A level decline detecting method for detecting, from a light signal formed by multiplexing a monitoring light used for transmission path monitoring and a signal light including data, a decline in a level of the signal light, the level decline detecting apparatus comprising:
obtaining, from the light signal input via a transmission path, a signal light level having a wavelength band level of the monitoring light suppressed and a monitoring light level having a wavelength band level of the signal light suppressed;
subtracting the signal light level from the obtained monitoring light level to calculate a level difference;
comparing the calculated level difference with a relative threshold value corresponding to a maximum level difference occurable between the monitoring light level and the signal light level; and
an output unit that outputs, if a comparison result of the comparing unit indicates that the calculated level difference is equal to or larger than the relative threshold value, a decline warning indicating a decline in the signal light level.

10. A level decline detecting method for detecting, from a light signal formed by multiplexing a monitoring light used for transmission path monitoring and a signal light including data, a decline in a level of the signal light, the level decline detecting method comprising:
obtaining, from the light signal input via a transmission path, a signal light level having a wavelength band level of the monitoring light suppressed and a monitoring light level having a wavelength band level of the signal light suppressed;
calculating, from the obtained monitoring light level, a leaked monitoring light level remaining in the signal light level having the wavelength band level of the monitoring light suppressed;
determining, as a lower limit of monitoring with respect to the signal light level, either one of the calculated leaked monitoring light level and a monitoring level during a dark current period when the obtained signal light level is not input;
comparing the determined lower limit with the obtained signal light level; and
outputting, if a comparison result at the comparing indicates that the signal light level is equal to or smaller than the lower limit, a lower limit notice indicating that the signal light level has declined outside a monitoring range.
